(19) United States
(12) Patent Application Publication
(10) Pub. No.: US 2025/0067032 A1
(43) Pub. Date: Feb. 27, 2025

(54) FAUCET WITH CASCADING RINSE MODULE

(71) Applicant: COMPASS MANUFACTURING INTERNATIONAL, LLC, Louisville, KY (US)

(72) Inventors: Ken Sapp, Lakeville, MN (US); DeChang Li, Maspeth, NY (US)

(21) Appl. No.: 18/784,884

(22) Filed: Jul. 25, 2024

Related U.S. Application Data
(60) Provisional application No. 63/528,693, filed on Jul. 25, 2023.

(51) Int. Cl. E03C 1/04; B05B 1/04; E03C 1/16

(52) U.S. Cl. CPC E03C 1/0405; B05B 1/044; E03C 1/16

(57) ABSTRACT

A faucet and cascading rinse module adapted for use in a sink wherein cascading water flows from the module in a selected laminar flow pattern for rinsing articles with a water-fall effect. A water supply device comprising dual selectable flow outlets, to dispense water from either a faucet positioned above a water basin or from a cascade module mounted adjacent to the water basin. The cascade module is modular to allow for alternative nozzle patterns to be used interchangeably in the water supply device. A cartridge valve controls water temperature and flow rate while a diverter valve directs the water supply to either the faucet head or to the plurality of nozzles of the cascade module.

### REFERENCE TO RELATED APPLICATIONS

This formal application claims priority from the U.S. provisional Application Ser. No. 63/528,693 filed on Jul. 25, 2023 which is incorporated by reference herein.

### FIELD OF THE INVENTION

A water discharge device combining a conventional faucet and a horizontally oriented cascading flow module for discharging water from a plurality of spaced apart aligned nozzles and forming a water fall of cascading water into a sink.

### BACKGROUND OF THE INVENTION

Water discharge devices for sinks typically include a faucet head suspended above the water basin which provides a primarily vertical stream of flow. These faucet heads may be extendable and retractable to provide a user with a greater range of direction of the flow but must be manually held in place. Further, these faucet heads can provide numerous types of flows such as a water sheet, a gentle rinse, or a powerful jet. What is lacking however, is a faucet combining both an overhead faucet head and a horizontally oriented cascading flow of water from the base of the faucet to provide a gentle laminar flow for rinsing. A plurality of spaced apart aligned nozzles horizontally oriented from the base of a faucet, or oriented at a slight downward angle, would provide a convenient means by which a sheet of cascading water may be used for quick and thorough rinsing.

### SUMMARY OF THE INVENTION

The current invention provides a water supply device comprising dual selectable flow outlets, to dispense water from either a faucet positioned above a water basin and/or from a cascade module mounted adjacent to the water basin. The cascade module is modular to allow for various nozzle patterns to be used interchangeably in the water supply device. A cartridge valve controls water temperature and flow rate, while a diverter valve directs the water supply to either the faucet head or to the plurality of nozzles of the cascade module. The cascade module may contain subsets of nozzles which can be individually selected based on an additional directional control valve built into the cascade module. The cascade module is integrated with a wall protruding from the faucet base, and the surfaces of the protruding wall are angled to direct excess water on the nozzles towards the water basin during and after use.

The present invention includes a water supply device adapted for installation in conventional sinks including a manifold having a plenum chamber filled with water in fluid communication with a plurality of nozzles formed in the sidewall or face of the module. A laminar sheet of water cascades from a plurality of nozzles along an elongated outlet. The plenum chamber is formed to buffer the input flow to help maintain a constant flow. The cascade module face may include openings defining nozzles or have a cap or panel fitted over the face, wherein the cap includes one or more rows of nozzles in a straight line, a curved wave pattern, or other selected configuration to modify the fluid outlet pattern. The water supply device is attached to the deck or ledge forming a flange around the sink supported by the cabinet so that the base of a faucet is formed as an integral part of the water supply device from which a cascade of water sprays from the spray nozzles of the cascade module and falls into the sink.

The cascade module provides a laminar flow of cascading water flowing into a sink. The water supply device includes both a cascade module and a conventional faucet, including plumbing fixtures and conduits for fluid communication with a pressurized water source adjacent to a sink. The device includes a fill plenum chamber for containing an amount of water, hot- and cold-water conduits, valves, and handles mounting to the device. A cap or insert having a selected configuration of orifices defining nozzles formed in a vertical face thereof is removably affixed to a side of the device facing the sink.

The valves of the water supply device control the direction, flow rate, and the ratio of hot and cold water discharged from the module. The primary valve is a cartridge valve having a full-on position, full-off position, or a partially on position between the full-on and full-off position, thereby allowing a user to gradually adjust the flow rate of the water. Further, the cartridge valve may provide a means to mix water sourced from a hot-water or cold-water inlet, thereby allowing the user to adjust the temperature of the water. In place of a cartridge valve, a ball valve or ceramic disc valve may be used. A diverter valve or transfer valve may be used to direct the water to dispense from only the desired outlets.

It is an object of the present invention to provide a laminar cascade delivery system integrated with faucets mounted to sinks wherein the rinse water is sprayed from a set of nozzles affixed to the sidewall of the water supply device facing the sink.

As an additional feature, air may be introduced by means of air inlet zones in flow communication with the channels feeding the spray nozzles of the module. The air can be drawn into the stream of water by venturi action and emerge from the nozzles as bubbles within the stream of water to provide aeration to the laminar flow of cascading water.

It is contemplated that the spray nozzles may also be formed as ball and socket nozzles wherein the position of the nozzles may be rotated and moved or directed up or down and side to side.

It is an object of the present invention to provide at least one and preferably layers of water spraying in a laminar cascading pattern by the water supply device for use as a rinse means with a faucet wherein means are provided to independently supply a portion of the water from the faucet to provide a cascade or waterfall effect through a device separate from the faucet using a separate opening in the device to achieve the cascading water flow effect.

It is an object of the present invention to provide a cascading water delivery system having a plurality of nozzles spaced apart on a cascade module in flow communication with the faucet water supply, operable independently of the faucet for dispensing a curtain of water therefrom in an elongated, wide and flat plurality of streams.

It is an object of the present invention to provide a module including a plurality of nozzles in one or more spaced apart horizontal rows.

It is an object of the present invention to provide a cascade water delivery unit with wide-mouthed rows for dispensing a curtain of water from a plurality of nozzles therefrom, wherein the device inlets are connected to a source of hot and cold water, and the device outlets are in flow communication with the atmosphere.

It is an object of the present invention to provide a water supply device defining a manifold including a removable cap in flow communication with the flow of water from a face of said module which includes a plurality of spaced-apart aligned nozzles in a selected configuration including a single row of spaced apart aligned nozzles for directing a cascade of water in a horizontal plane, a double row of spaced apart aligned nozzles for directing a cascade of water in a horizontal plane, and/or a triple row of spaced apart aligned nozzles for directing a cascade of water in a horizontal plane. The nozzles in the cap may be positioned to form a straight line providing a laminar spray, a curved line providing a wave spray, or a plurality of nozzles in series spaced apart to form multiple sprays of water.

It is an object of the present invention to provide a water supply device having a removable cap fitting over the face of the module in flow communication with the manifold for directing water flowing through a plurality of nozzles formed in said cap wherein a first row of nozzles directs water in at selected upward angle of less than 90 degrees with respect to a horizontal plane, a second row of nozzles direct water in a horizontal plane, and an optional third row of nozzles direct water in at selected downward angle of less than 90 degrees with respect to a horizontal plane resulting in at least two rows of cascading water spraying into a sink at different distances from the sidewall of the sink.

Control of the liquid flow is regulated by suitable valving controlled by the faucet handles attaching to the water conduits, the valving means preferably located at or near the point of entry of the flow of fluid into the chamber with individual exterior valve controls.

Installation of the water supply device to a sink includes suitable valving means for the water conduits, the valving means preferably located at or near the point of entry of the conduits into the module chamber. Installation of the module to a sink is affected by mounting the module to the lip or flange of the sink by a suitable selected mounting means sufficient to secure the unit adjacent to the sink, for example by threaded inserts. Anchoring components integrally attached to the base of the unit are secured to the sink with the cascade module and water nozzles directed toward the interior of the sink.

Other objects, features, and advantages of the invention will be apparent with the following detailed description taken in conjunction with the accompanying drawings showing a preferred embodiment of the invention.

### BRIEF DESCRIPTION OF THE DRAWINGS

The accompanying drawings are incorporated into and form a part of the specification to illustrate examples of the aspects, embodiments, or configurations disclosed herein. The drawings together with the description, are meant to explain the principal aspects, embodiments, or configurations of the invention. The drawings illustrate preferred and alternative examples of the aspects, but are not intended to limit the aspects, embodiments, or configurations to only the illustrated and described examples. Additional features and advantages will become apparent from the following, more detailed, description of the various aspects, embodiments, or configurations, as illustrated by the drawings referenced below. Reference numbers are the same for those elements that are the same across different Figures, wherein:

FIG. 1 is a perspective view of a first embodiment of a water supply device.

FIG. 2 is a detailed side view of the water supply device of FIG. 1, illustrating the minimum and maximum flow rate positions of a cartridge valve.

FIG. 3 is a detailed side view of the water supply device of FIG. 1, illustrating the minimum and maximum temperature positions a cartridge valve.

FIG. 4 is a detailed top view of the water supply device of FIG. 1, illustrating the positions of a diverter valve.

FIG. 5 is a bottom perspective view of the water supply device of FIG. 1, illustrating mounting hardware.

FIG. 6 is a perspective view of a first embodiment of an internal flow path of the water supply device of FIG. 1.

FIG. 7 is a cross-sectional view of a second embodiment of an internal flow path of the water supply device of FIG. 1.

FIG. 8 is a perspective view of a water supply device mounted adjacent to a water basin.

FIG. 9 is a detailed side view of the water supply device mounted adjacent to a water basin of FIG. 8.

FIG. 10 is a detailed side view of a water supply device mounted adjacent to a water basin atop a raised mounting surface.

FIG. 11a is a side view of the water supply device of FIG. 1.

FIG. 11b is a detailed side view of the water supply device of FIG. 11a with the device turned on and dispensing from the cascade module.

FIG. 11c is a detailed side view of the water supply device of FIG. 11a with the device turned off and excess water accumulating and collecting in the water basin due to the angled surfaces of the protruding wall.

FIG. 12 is a detailed perspective view of a sink accessory beneath the protruding wall of the water supply device of FIG. 1 supported by the rim of a water basin.

FIG. 13 is a front view of the water supply device of FIG. 1.

FIG. 14 is a front view of a second embodiment of the water supply device.

FIG. 15 is a detailed perspective view of an additional embodiment of the water supply device in which the cascade module is interchangeable.

FIGS. 16a and 16b are detailed perspective views of an additional embodiment of the water supply device, illustrating the diversion of the flow of water through a dual-basin cascade module dependent upon the configuration of the valve.

FIGS. 17a through 17c are perspective views of the water supply device of FIG. 1 having the faucet base housing hidden to illustrate the means of mounting the cascade module.

### DETAILED DESCRIPTION OF THE INVENTION

Various embodiments of the present invention are described herein and depicted in the drawings. To acquaint persons skilled in the pertinent arts most closely related to the present invention, a preferred embodiment that illustrates the best mode now contemplated for putting the invention into practice is described herein by, and with reference to, the annexed drawings that form a part of the specification. This exemplary embodiment is described in detail without attempting to describe all the various forms and modifications in which the invention might be embodied. As such, the embodiments described herein are illustrative and, as will become apparent to those skilled in the arts, may be modified in numerous ways within the scope and spirit of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature structure, or characteristic in connection with other embodiments, whether or not explicitly described.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” or “an”, “one or more” and “at least one” can be used interchangeably herein.

The use of “including,” “comprising,” or “having,” and variations thereof herein is meant to encompass the items listed thereafter and equivalents thereof as well as additional items. Accordingly, the terms “including,” “comprising,” or “having,” and variations thereof can be used interchangeably herein.

It shall be understood that the terms “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

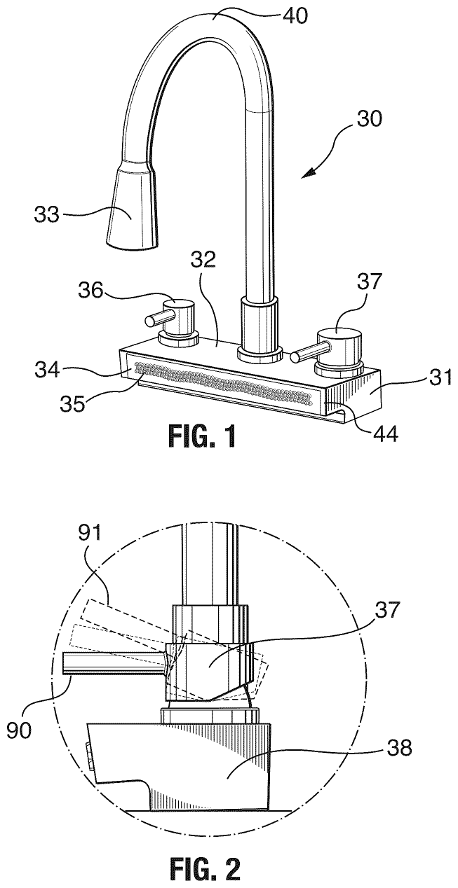

Referring now to FIG. 1, a water supply device 30 according to a first embodiment of the present invention comprises: a faucet base 31, an elongated curved outlet pipe 40 extending upward from the top surface 32 of the base 31, a conventional faucet head 33 attached to the distal end of the elongated curved outlet pipe, a cascade module 34 having a plurality of nozzles 35 mounted on protruding wall 44 of the base 31, a diverter valve 36 for diverting water to either the faucet head 33 or the cascade module 34, and a cartridge valve 37 for adjusting the flow rate of the water through the water supply device 30 and adjusting the mix of hot water and cold water from a hot water supply and cold water supply to thereby adjust the temperature of the water dispensed by the water supply device 30. Alternatively, a ball valve or ceramic disc valve may be used in place of the cartridge valve.

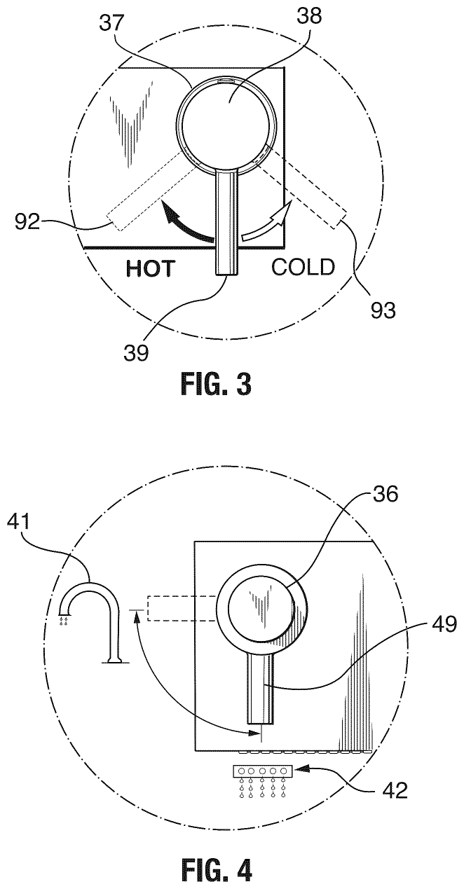

As further illustrated in FIGS. 2-3, the cartridge valve 37 can be rotated about its mounting axis 38 to adjust the ratio of hot water and cold water and pivoted about the faucet base 31 to increase or decrease the flow rate of water through the supply device 30. The cartridge valve 37 has a flow off position 90, a max flow rate position 91, a hot-water position 92, and a cold-water position 93. The valve may be adjusted to any position between the minimum and maximum temperature and flowrate positions to variably adjust the temperature and flowrate as desired by the user. A first handle 39 may extend from the cartridge valve 37 to improve the user's ability to manipulate the valve.

As illustrated in FIG. 4, a second handle 49 may extend from the diverter valve 36 to improve the user's ability to manipulate the valve. The diverter valve 36 has a faucet dispensing position 41 and a cascade module dispensing position 42 which may be selected by the user. When the faucet dispensing position 41 is selected, water is diverted to be dispensed from the faucet head 33. When the cascade module dispensing position 42 is selected, water is diverted to be dispensed from the cascade module 34. It will be appreciated that diverter valve is not necessarily a binary selector, and the user may select a position between the faucet dispensing position and the cascade module dispensing position to dispense from both the faucet head 33 and the cascade module 34 simultaneously.

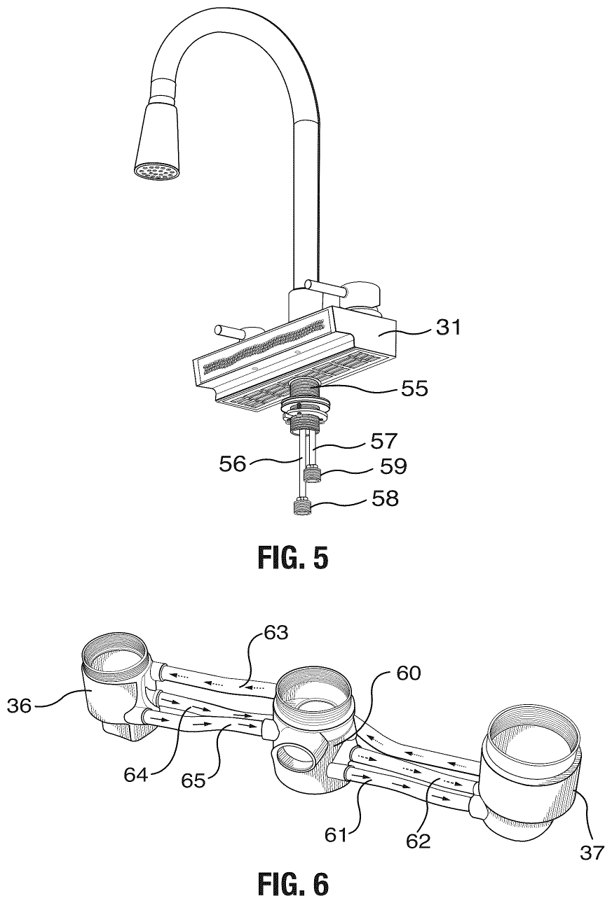

A threaded pipe 55 extends from the bottom of the faucet base 31, through which a hot-water supply line 56 and a cold-water supply line 57 are connected interiorly to a central manifold 60, as illustrated in FIG. 5. The hot-water connector 58 and cold-water connector 59 extend beyond the threaded pipe 55 for easy access during installation of the faucet.

The interior fluid flow path of the faucet base 31 comprises the central manifold 60 which directs the hot and cold-water inlets to the cartridge valve 37. The cartridge valve has two ports for receiving the hot and cold water and can vary the ratio of hot and cold water to a desired temperature, as well as regulate the volume flow rate to the cartridge valve outlet. Once the water is mixed by the cartridge valve, it is directed to the diverter valve 36 to be directed to either the faucet head 33 or to the cascade module 34. An exemplary embodiment of the interior fluid flow path is illustrated in FIG. 6 wherein a hot-water tube 61 and a cold-water tube 62 connect the central manifold 60 to the cartridge valve 37. A mixed flow of water is supplied to the diverter valve 36 through an intermediary tube 63, wherefrom the mixed flow of water can be supplied to either the faucet head 33 through the faucet head tube 64 or to the cascade module 34 through the cascade module tube 65. In the embodiment of FIG. 6, the faucet head tube and cascade module tube are redirected to the central manifold 60 to be distributed to either the faucet head 33 or the cascade module 34. In an alternative embodiment, the outlet tubing of the diverter valve may be directly connected to the faucet head 33 and the cascade module 34.

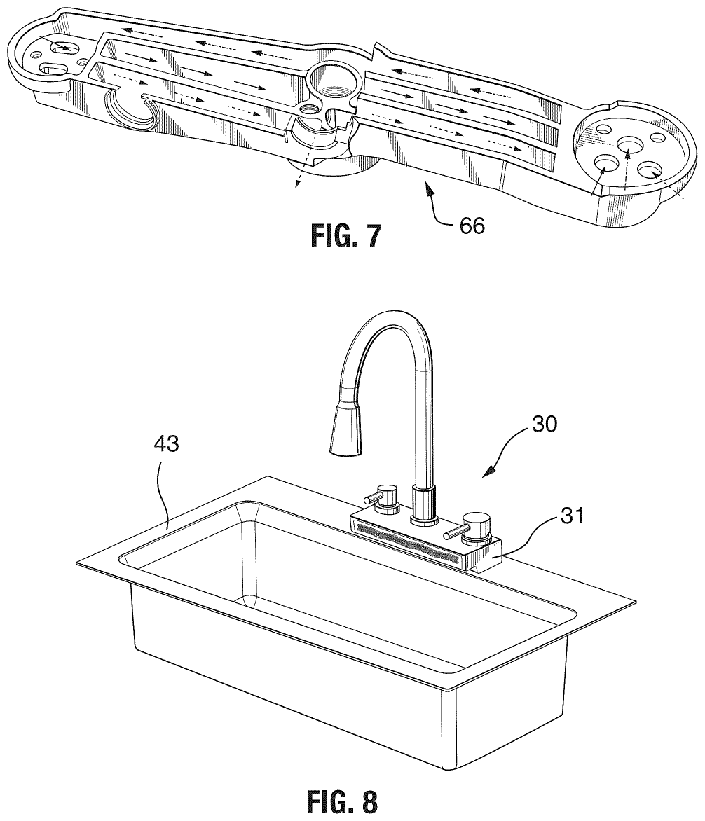

An additional embodiment of the internal fluid flow path is illustrated in the cross-sectional view of FIG. 7, wherein the central manifold, cartridge valve, and diverter valve are formed as a unitary manifold 66, thereby increasing robustness of the system by eliminating joints where fluid may begin leaking after years of use.

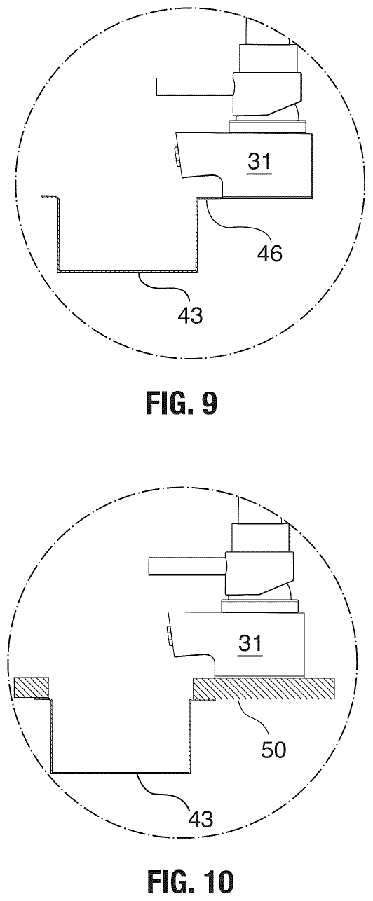

The water supply device 30 is intended to mount to a horizontal surface adjacent to a water basin 43, such as a sink, with the cascade module pointed towards the basin, as illustrated in FIG. 8. The threaded pipe 55 is sized appropriately to fit into the mounting hole of a standard one-hole kitchen sink. However, the faucet base 31 is designed sufficiently wide to cover all the mounting holes of a standard three-hole kitchen sink. This allows the single faucet to be used with a wider variety of kitchen sinks without sacrificing visual appeal or requiring caps for the additional mounting holes. The threaded pipe 55 is sufficiently long so that the faucet base 31 can be either mounted directly to the sink mounting surface 46 or to a secondary raised mounting surface 50 such as a sheet of marble, wood, or granite overlapping the outer rim of the water basin 43, shown in FIG. 9 and FIG. 10.

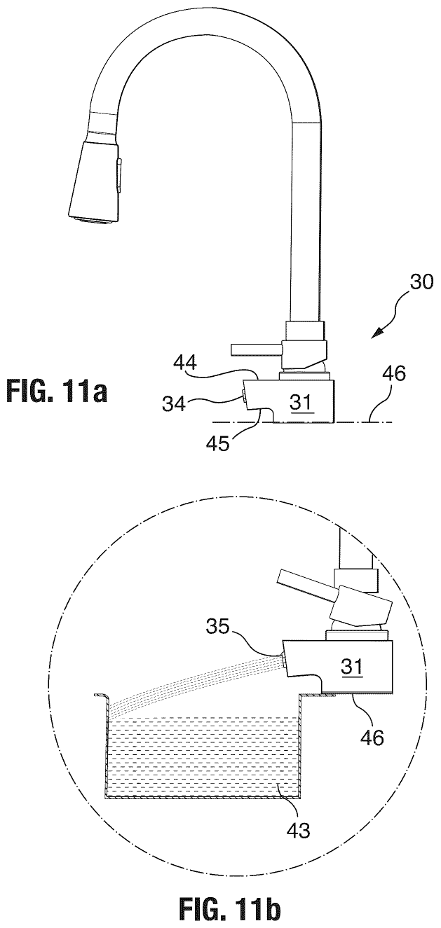

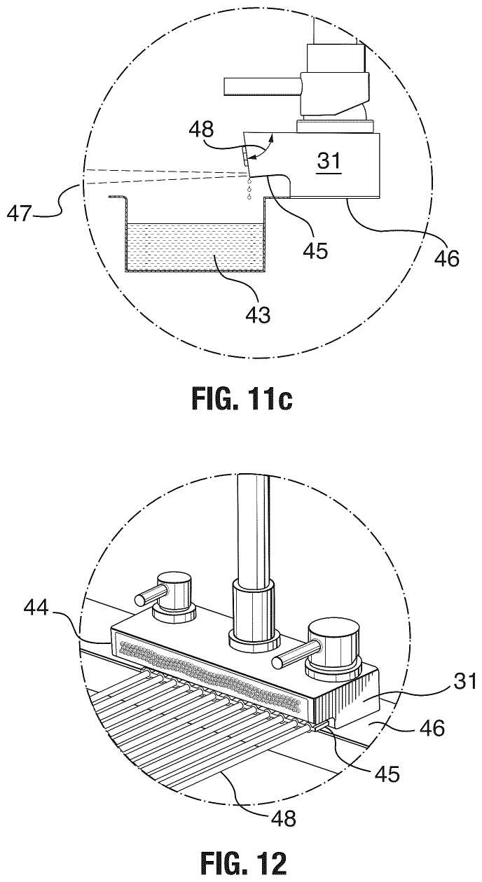

Referring now to FIGS. 11a-11c, the cascade module 34 is integrated with a wall protruding from the faucet base 31, and the surfaces of the protruding wall 44 are angled to direct excess water on the nozzles towards the water basin 43 during and after use of the water supply device. The protruding wall 44 extends from the top of the front face of the faucet base 31, and a gap is formed between the bottom surface 45 of the protruding wall 44 and the mounting surface 46. The gap extends along the length of the faucet base 31 and is sufficient in height to allow sink accessories such as a rack 80 (illustrated in FIG. 12), a cutting board (not illustrated), or a colander/rinse basket (not illustrated), to be supported by the rim of the water basin 43 without interference with the water supply device 30.

The profile of the protruding wall 44 is specially designed to ensure water from the plurality of nozzles 35 does not trickle down the faucet base 31 and puddle on the mounting surface 46 onto which the water supply device 30 is secured, which could cause discoloring, staining, or structural damage to the mounting surface after repeated exposure. The protruding wall 44 extends away from the faucet base 31 at a distance sufficient to ensure the cascade module 34 terminates above the water basin 43 when mounted to a standard sink basin. The bottom surface 45 of the protruding wall 44 is angled downwards so that excess water dripping from the plurality of nozzles 35 is directed into the water basin 43 due to gravity. The angle 47 of the bottom surface 45 of the protruding wall 44 must be 0-90 degrees downwards, non-inclusive, relative to a plane perpendicular to gravity. The bottom surface angle 47 has been optimized so that the protruding wall 44 may extend outwards into the basin while ensuring a sufficient gap for accessories between the bottom surface 45 and the mounting surface 46 and maintaining its water-shedding abilities. The bottom surface angle 47 is preferably 0-45 degrees, more preferably 0-30 degrees, and most preferably 5-15 degrees. Further, the front face of the cascade module 34 forms a preferably 45-90 degrees, more preferably 70-85 degrees, and most preferably an 80 degrees angle 48 with respect to the top face of the faucet base 31 so that drips from the spray nozzles will fall into the sink or water basin rather than flow back along the bottom of the protruding wall towards the faucet fixture base. An additional benefit of angling the cascade module downward is ensuring that water dispensed from the plurality of nozzles 35 will not overshoot the opposing wall of a standard sized water basin 43 when dispensing at the maximum flow rate.

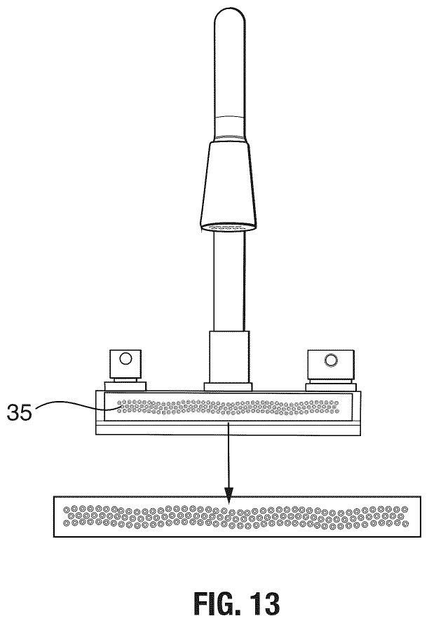

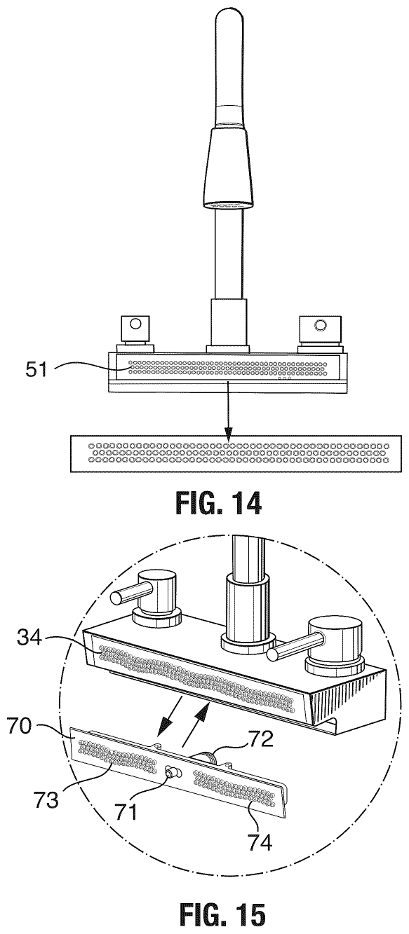

The plurality of nozzles 35 may be manufactured of metal, plastic, or ceramic material sets. A rubber-based or silicone-based material set is preferred for its increased cleanability. In a preferred embodiment, illustrated in FIG. 13, the plurality of nozzles 35 is arranged in a multi-row sinusoidal pattern, providing a visually pleasing water dispense pattern and unique dispense coverage. In an alternative embodiment, illustrated in FIG. 14, the plurality of nozzles 51 is arranged in a multi-row pattern where alternative rows are offset by a half pitch along the length of the row. The half pitch offset between alternative rows helps to ensure more even coverage of the dispensed water. It will be appreciated by one who is skilled in the art that the nozzles may be various sizes or located in various positions to modify the dispensing behavior of the water supply device 30. Alternative embodiments may contain only a single row of nozzles, or more than the three rows of nozzles illustrated.

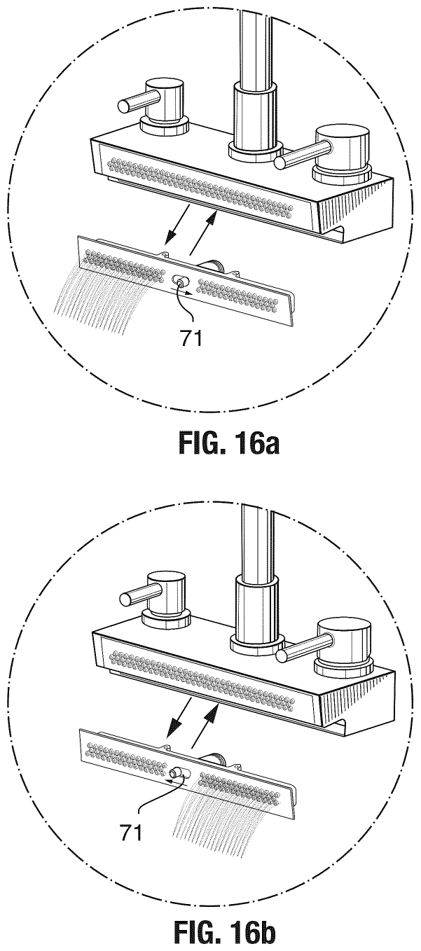

The cascade module 34 may be removed from the protruding wall 44 and interchanged for an alternative cascade module not only to obtain alternative nozzle patterns, but also to obtain additional functions as well. In an alternative embodiment, illustrated in FIG. 15, a dual-basin cascade module 70 includes an additional valve 71, either a directional control valve or a diverter valve, at the module's inlet port 72 to further direct the water to either a first set of nozzles 73, a second set of nozzles 74, or a combination thereof. It will be appreciated by one who is skilled in the art that additional nozzle sets may be included or subdivided between. The dual-basin cascade module 70 provides the means for a user to dispense a cascading sheet of water into either side of a dual-basin sink, or between multiple accessories. An alternative embodiment of the dual-basin cascade module featuring a linear array of a plurality of nozzles is shown in FIGS. 16a-16b. It is further demonstrated how the additional valve 71 may be switched between multiple positions to divert the water between the multiple sets of nozzles.

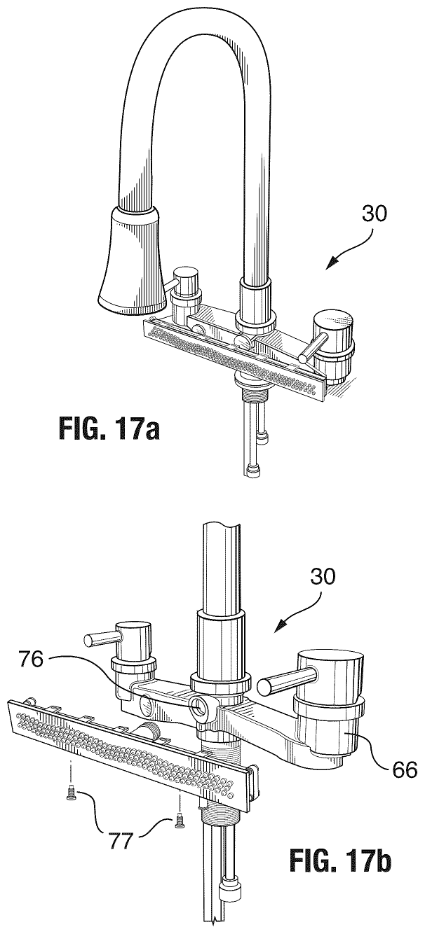

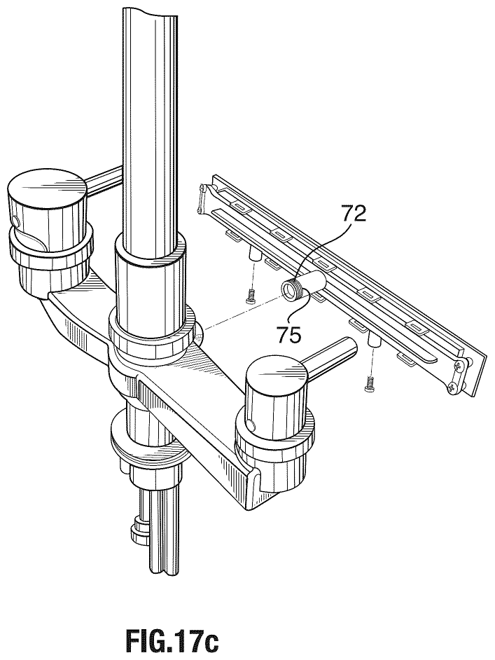

The removable cascade module 34 may be secured to the faucet base 31 by a press-fit, snap-fit, fastened with bolts or screws, or a combination thereof. Illustrated in FIGS. 17a-17c, in an exemplary embodiment having the faucet base 31 hidden, a cascade module inlet port 72 having at least one gasket or O-ring 75 mounted at the distal end can be press-fit into the into the cascade module outlet 76 of the unitary manifold 66 of the water supply device 30. The O-ring 75 ensures a proper seal between the inlet port and the manifold to prevent leaking. Once seated, a set of screws 77 can be inserted through mounting holes (not illustrated) in the bottom surface 45 of the protruding wall 44 to fasten the cascade module into place.

In an alternative embodiment, the faucet head 33 may be that of a pull-down type, whereby the faucet head may be extended by the user beyond its nesting position at the distal end of elongated curved outlet pipe 40, thereby allowing better manipulation of the direction of the dispensed water. The pull-down faucet head may retract back into its nesting position once released by the user.

The disclosure has been described with reference to various specific embodiments and techniques. However, it should be understood that many variations and modifications may be made while remaining within the spirit and scope of the invention. It is appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any sub-combination.

What is claimed is:

1. A sink faucet having a cascading rinse module device for discharging water in the form of a waterfall into a sink, comprising:
a sink having a faucet mounting thereon in flow communication with a pressurized water source including a valve means for controlling the flow rate of the water through said faucet;
a water discharge module mounted in close proximity to said faucet in flow communication with a pressurized water source including a valve means for controlling the flow rate of water through said module, said module including an outer wall formed with a plurality of spaced apart horizontal discharge nozzles directing a cascade of water toward said sink;
said module including a reservoir chamber for holding, as reserve water, water flowing into the discharge path from its upstream side, and is formed with a constricting flow path from a reservoir chamber side to a face of said module including at least one row of said plurality of spaced apart discharge nozzles, discharging said water in a horizontal plane of cascading water into said sink, the cascade having a constant flow path height from over said sink;
said cascading water forming a water fall along a selected width of said sink and at a distance determined by the amount of water flowing through the module.

2. A water supply device mounted to a mounting surface comprising:
a faucet base having an internal flow path directing inlet water through a manifold from a hot-water source and a cold-water source to a faucet valve, said hot-water source and cold-water source being combined and rate-regulated by said faucet valve;
a diverter valve having an inlet port sourcing the rate-regulated water from said faucet valve and diverting said rate-regulated water to either a faucet head, a cascade module, or a combination thereof;
wherein said faucet head is mounted at the distal end of an elongated curved outlet pipe above a water basin;
and wherein said cascade module is integrated with the side wall of the faucet base so that a plurality of nozzles are directed towards said water basin to provide a cascading water fall into said basin for rinsing.

3. The water supply device of claim 2 wherein the plurality of nozzles of the cascade module are arranged in at least one horizontal row.

4. The water supply device of claim 2 wherein the plurality of nozzles of the cascade module are arranged in a sinusoidal pattern.

5. The water supply device of claim 2 wherein the cascade module is interchangeable to provide alternative nozzle patterns for a single water supply device.

6. The water supply device of claim 2 wherein the cascade module is mounted to a wall protruding from the top of the side wall of the faucet base so that there exists a gap between the bottom surface of the protruding wall and the mounting surface for inserting a rinsing accessory such as a rack, colander, or basket, between the bottom surface and the mounting surface, supported by the rim of said water basin.

7. The water supply device of claim 6 wherein a bottom surface of the protruding wall is angled downwards between 0 and 45 degrees so that excess dripping water is directed into the water basin.

8. The water supply device of claim 6 wherein a bottom surface of the protruding wall is angled downwards between 0 and 30 degrees with respect to a plane perpendicular to gravity.

9. The water supply device of claim 6 wherein a bottom surface of the protruding wall is angled downwards between 5 and 15 degrees with respect to a plane perpendicular to gravity.

10. The water supply device of claim 6 wherein a front face of the protruding wall is angled downward between 45 and 90 degrees with respect to a top face of the faucet base.

11. The water supply device of claim 6 wherein a front face of the protruding wall is angled downward between 70 and 85 degrees with respect to a top face of the faucet base.

12. The water supply device of claim 6 wherein a front face of the protruding wall is angled downward at 80 degrees with respect to a top face of the faucet base.

13. The water supply device of claim 2 wherein the plurality of nozzles of the cascade module are made from an elastomeric material selected from a group consisting of: ethylene propylene diene monomer (EPDM), fluorocarbon, neoprene, nitrile, silicone, and viton.

14. The water supply device of claim 2 wherein the cascade module has at least two independent sets of nozzles which can be selected between using a diverter valve integrated with cascade module.
